(19) United States
(12) Patent Application Publication
(10) Pub. No.: US 2008/0110869 A1
(43) Pub. Date: May 15, 2008

(54) Method of machining mold surface using laser

(75) Inventor: Chung Lung Chen, Taipei City (TW)

Correspondence Address: RABIN & Berdo, PC, 1101 14TH STREET, NW, SUITE 500, WASHINGTON, DC, 20005, US

(73) Assignee: BUTTON INTERNATIONAL CO., LTD.

(21) Appl. No.: 11/599,609

(22) Filed: Nov. 15, 2006

(51) Int. Cl. B23K 26/06

(52) U.S. Cl. 219/121.75

(57) ABSTRACT

A method of machining a mold surface using laser includes the steps of preparing a laser device and an optical zoom lens assembly disposed in front of the laser device; using a computer to compute a sectional curvature of the mold surface to be machined, so as to obtain parameters for controlling variance in laser focal length; and machining the mold surface twice to remove mold material from desired areas and to polish the mold surface, so that the machined areas are blended with the original coarse surface to show the designed patterns while showing a polishing effect. Therefore, a product molded using the machined mold would show different changes or refraction of light.

### FIELD OF THE INVENTION

The present invention relates to a method of machining mold surface using laser, and more particularly to a method of machining mold surface using a laser device and a zoom lens assembly disposed in front of the laser device, so that a laser focal length may be quickly adjusted via the zoom lens assembly to enable effective and accurate machining of mold surface.

### BACKGROUND OF THE INVENTION

The currently available laser machining techniques may be generally divided into two types, namely, CO₂ laser machining, which is generally applied in non-metal mold machining, and YAG (yttrium aluminum garnet) laser machining, which is generally suitable for metal mold machining.

In the case of YAG laser machining, the machining is controlled via three basic parameters, namely, laser power (%), laser frequency (kHz), and laser engraving speed (mm/s).

Please refer to FIGS. 1 and 1A. A mold 1 usually has a surface 11, which is a coarse surface when being observed with a high-power magnifier. Therefore, a product formed using the mold 1 does not have smooth outer surface. For the mold to have a smooth surface, laser machining techniques are employed to machine the mold surface. To machine a curvy surface, the laser must have a variable focus. However, in the conventional laser machining techniques, the laser has a fixed focus, and the worktable carrying the mold to be machined is mechanically moved upward and downward (that is, moved in z-direction). Since the mechanically moved worktable can only move at a slow speed, the mold is not accurately machined to produce a smooth surface.

In addition, while the conventional laser machining techniques improve the coarse mold surface to some extent, they do not produce desirable changes on the machined mold surface. Therefore, the products formed using the conventional laser machined molds usually have monotonous outer surfaces that do not attract consumers at all.

### SUMMARY OF THE INVENTION

A primary object of the present invention is to provide a method of machining mold surface using laser, in which an optical zoom lens assembly is disposed in front of a laser device, so that the laser focal length may be quickly adjusted via optical zoom to enable effective machining of mold surface. Therefore, it is possible to eliminate the problem of inaccurately machined mold surface due to a mechanically slowly moved machining worktable that fails to successfully work with a laser device.

Another object of the present invention is to provide a method of machining mold surface using laser, in which a computer is used before machining to compute a sectional curvature of the mold surface to be machined, so as to obtain parameters for controlling variance in laser focal length, and accordingly achieve the goal of precisely machining the mold surface.

A further object of the present invention is to provide a method of machining mold surface using laser, in which the mold surface is laser machined twice to remove mold material from desired areas and to polish the machined mold surface, so that the machined areas are blended with the original coarse mold surface to show designed patterns while exhibiting a polishing effect.

Therefore, a product formed using the mold would show different changes or refraction of light on an outer surface.

To achieve the above and other objects, the method of machining mold surface using laser according to the present invention includes the steps of:
(a) using a computer to compute a curvature of a mold surface to be machined, so as to obtain parameters for controlling variance in laser focal length;
(b) using an optical zoom lens assembly to quickly vary the laser focal length, so as to perform material removal machining on the mold surface;
(c) adjusting a laser power parameter, so that material in a predetermined area on the mold surface is removed using heat energy of laser;
(d) thereafter, measuring laser frequency and laser power based on a previous working path; and
(e) reducing the laser power parameter and repeating a polish machining on the mold surface.

In brief, in the method of the present invention, with the zoom lens assembly disposed in front of the laser device, the laser device is able to more quickly change the focus projection. And, since the mold surface is subjected to machining twice, including material removal and polishing, the machined areas are blended with the coarse surface to show designed patterns while showing the polishing effect. Therefore, a product molded using the mold would have an outer surface showing different changes and refraction of light.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic view showing a mold surface;

FIG. 1A is an enlarged view of the circled area of FIG. 1;

FIG. 2 shows an example of machining a mold surface using laser according to the method of the present invention;

FIG. 3 shows a zoom lens assembly used in the present invention is varying the laser focal length;

FIG. 4 shows the mold surface is being polished using laser according to the method of the present invention; and

FIG. 5 shows the area on the mold surface that has been machined as shown in FIG. 4.

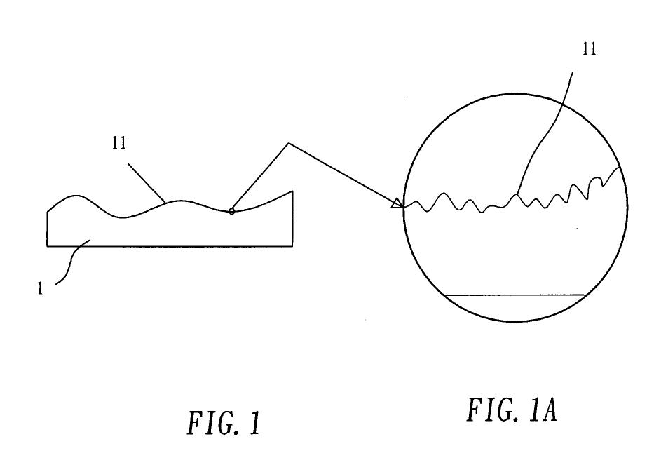

### DETAILED DESCRIPTION OF THE PREFERRED EMBODIMENTS

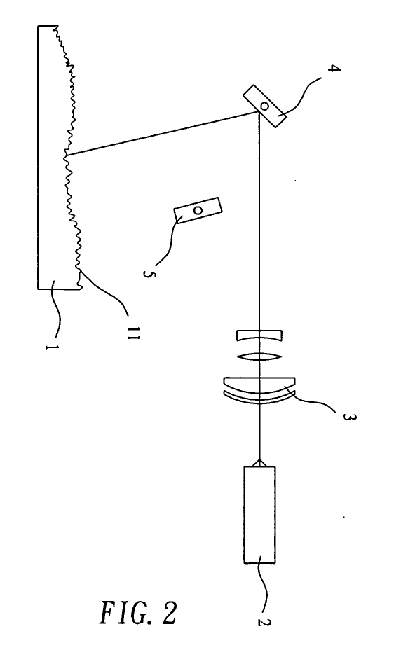

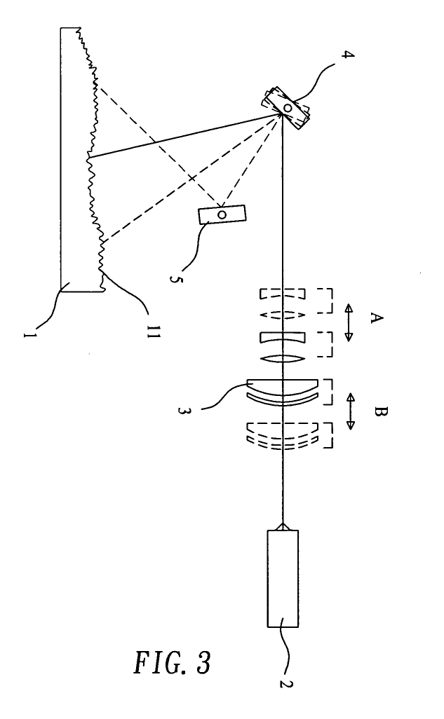

Please refer to FIGS. 2 and 3. In implementing a method of machining a mold surface using laser according to the present invention, there are prepared a laser device 2 and an optical zoom lens assembly 3 disposed in front of the laser device 2. Through optical zoom to achieve displacement of laser focus, the purpose of accurately machining a mold surface may be realized. The method of machining a mold surface using laser according to the present invention includes the following steps:
(a) using a computer to compute a curvature of a surface 11 of a target workpiece or mold 1 to be machined, so as to obtain parameters for controlling variance in laser focal length;
(b) using the zoom lens assembly 3 to quickly vary the laser focal length for the laser device 2, so as to perform material removal machining on the surface 11 of the target workpiece 1;
(c) adjusting a laser power parameter, so that material in a predetermined area on the surface 11 of the target workpiece 1 is removed using laser heat energy;
(d) thereafter, measuring laser frequency and laser power based on a previous working path; and
(e) reducing the laser power parameter and repeating a polish machining on the surface 11 of the target workpiece 1.

To enable the laser device 2 to quickly change its laser focus projection in response to the curvy surface 11 of the target workpiece 1, the zoom lens assembly 3 is disposed in front of the laser device 2. While the zoom lens assembly 3 has very complicate structure, FIG. 3 only schematically shows the manner in which the zoom lens assembly 3 displaces to vary the laser focal length. The zoom lens assembly 3 varies the focal length at a speed absolutely much higher than the speed at which the conventional worktable is mechanically moved upward and downward. Therefore, the laser device 2 may change its laser focus projection at a largely increased speed.

In an ideal embodiment of the present invention, the zoom lens assembly 3 is an optical zoom lens assembly.

In an operable embodiment of the present invention, reflection mirrors 4, 5 are further provided to refract a laser beam from the laser device 2. The reflection mirrors 4, 5 cooperate with the optical zoom lens assembly 3 to enable a further widened laser machining range, and accordingly, enable the target workpiece 1 to be more efficiently machined.

More specifically, in the step (a), before starting machining the target workpiece or mold 1, a computer is used to compute the sectional curvature of the surface 11 of the target workpiece 1, and to derive from the sectional curvature the length of a vertical side of a right triangle using trigonometric functions, so as to obtain variations in laser focal length for the laser device 2. The above-mentioned sectional curvature is obtained from numerous points on a sectional curve of the workpiece 1. However, not all the points on the sectional curve of the target workpiece 1 are machinable. It is necessary to compute the sectional curvature to obtain an approximate value thereof. By laser machining the numerous points on the sectional curve that are to be machined according to the computer computation, a line or an area may be formed.

In terms of the YAG laser that is more suitable for metal machining, laser power (%), laser frequency (kHz), and laser engraving speed (mm/s) are three basic parameters that control and determine the effect of machining using laser.

In the step (b), the zoom lens assembly 3 is used to quickly change the laser focal length, so as to properly machine the surface 11 of the target workpiece 1. Through displacement of optical lenses included in the zoom lens assembly 3, such as displacing the lenses within the ranges A and B as indicated in FIG. 3, it is possible for the laser focal length to very accurately fall on the curvy surface 11 of the target workpiece 1. Moreover, by refracting the laser beam with the reflection mirrors 4, 5, the laser machining may be repeatedly performed at different areas on the surface 11 to finally present a highly accurately machined workpiece surface.

In the step (c), the parameters for laser machining, including laser power (%), laser frequency (kHz), and laser engraving speed (mm/s), may be adjusted or controlled on the laser device 2 according to predetermined patterns or machining depths, so that a desired amount of material may be effectively removed from specific areas on the surface 11 of the target workpiece 1 by heat energy of laser projected from the laser device 2.

Different materials might require different levels of laser power, laser frequency, and temperature to complete the machining. In one example, the mold to be surface machined according to the method of the present invention is made of a type of pre-hardened mold steel named NAK 80, and the laser machining parameters are adjusted on the laser device 2 for the heat energy generated at each focus of the projected laser to just remove an amount of material of 0.002 mm in thickness from the surface 11 of the target workpiece 1.

As a matter of fact, it is extremely difficult to adjust the working parameters for laser machining. To enable easier understanding of the importance in varying the parameters in laser machining, only one of the working parameters, that is, the temperature, is discussed herein. In the case of a target workpiece 1 made of the pre-hardened mold steel NAK 80, NAK 80 may be carbonized by laser having a reasonable frequency range from about 400 kHz to about 450 kHz at a temperature range from about 2000 to 2500° C. to achieve a machining depth of about 0.002 mm. Theoretically speaking, the machining depth of 0.002 mm is smaller than a sectional difference of the coarse surface 11 of the target workpiece 1. Therefore, it is possible to machine over the coarse grains of the surface 11 to show desired lines or patterns. At this point, the laser machined areas have blended with the coarse surface 11 to produce the designed configuration.

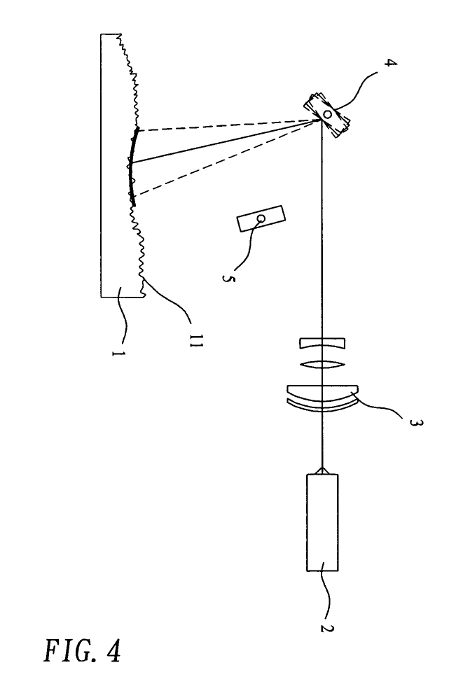

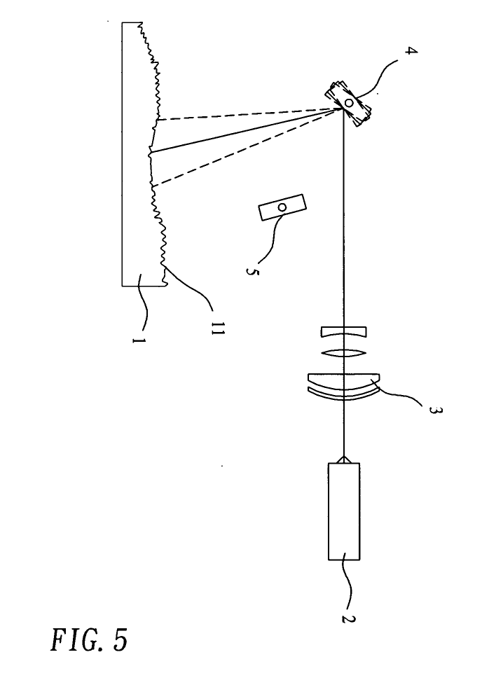

Please refer to FIG. 4. When the machining in the steps (a) to (c) has been completed, and it is desired to create a more finely blended surface 11 on the target workpiece 1, the steps (d) and (e) are performed. In the step (d), new working parameters for the laser device 2, including laser frequency and laser power, are measured using the computer based on the previous working path. In the case of a mold made of NAK 80, when a preferable working temperature range from about 1500 to about 1700° C., and a relatively higher laser frequency and relatively lower laser power are adopted in further mold surface machining, the metal material is not subject to carbonization, but a melting effect, which is generally referred as a surface thermal ionization, would occur. At this point, due to the surface thermal ionization, molecules at the surface 11 of the target workpiece 1 are re-oriented to form a smooth surface, as the machined areas shown in FIG. 5. The same machining procedures are repeated along the same working path for 10 to 20 times, so that the machined areas are looked like having been polished. In this way, on the surface 11 of the target workpiece 1, machined lines and areas or patterns would be presented on the originally coarse surface 11 while the machined areas would show the polishing effect.

In brief, in the present invention, with the zoom lens assembly 3 disposed in front of the laser device 2, the laser device 2 is able to more quickly change the focus projection. And, since the surface 11 of the target workpiece 1 is subjected to machining twice, including material removal and polishing, the machined areas are blended with the coarse surface to show the designed patterns while the machined areas exhibits the polishing effect. Therefore, a product molded using the target workpiece 1 (that is, the mold) would have an outer surface showing different changes or refraction of light.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method of machining mold surface using laser, comprising the steps of:
preparing a laser device for generating laser, and a zoom lens assembly disposed in front of the laser device;
using a computer to compute a curvature of a surface of a target workpiece, so as to obtain parameters for controlling variance in laser focal length;
the zoom lens assembly to quickly vary the laser focal length for the laser device, so as to perform material removal machining on the surface of the target workpiece;
adjusting a laser power parameter, so that material in a predetermined area on the surface of the target workpiece is removed using laser heat energy;
thereafter, measuring laser frequency and laser power based on a previous working path; and
reducing the laser power parameter and repeating a polish machining on the surface of the target workpiece.

2. The method of machining mold surface using laser as claimed in claim 1, wherein the laser device is a YAG laser device.

3. The method of machining mold surface using laser as claimed in claim 1, wherein the zoom lens assembly is an optical zoom lens assembly.
